(19) United States
(12) Patent Application Publication
(10) Pub. No.: US 2019/0264821 A1
(43) Pub. Date: Aug. 29, 2019

(54) BYPASS VALVE

(71) Applicant: Xiamen Filtertech Industrial Corporation, Xiamen (CN)

(72) Inventor: Feng-Shun Zhan, Xiamen (CN)

(21) Appl. No.: 16/286,048

(22) Filed: Feb. 26, 2019

(30) Foreign Application Priority Data
Feb. 26, 2018 (CN) 201820272315.5

(51) Int. Cl. F16K 11/04

(52) U.S. Cl. CPC F16K 11/04

(57) ABSTRACT

A bypass valve includes a first main body, with its two ends disposed a water inlet port and a water outlet port respectively. A mandrel capable of moving laterally is disposed in the first main body, and a water passage channel is disposed in the mandrel, for connecting and communicating the water inlet port with the water outlet port. A second main body is disposed below the first main body. In the second main body is disposed a water inlet channel and a water outlet channel, a first water passage hole is disposed between the water outlet channel and the water inlet port, and a second water passage hole is disposed between the water inlet channel and the water outlet port. The bypass valve is simple in construction, and is capable of achieving multi water routes switching.

### BACKGROUND OF THE INVENTION

### Field of the Invention

The present invention relates to a valve, and in particular to a bypass valve.

### The Prior Arts

Presently, the existing bypass valve structure uses mainly two approaches of switching.

1. Utilizing two mandrels to rotate in a receiving chamber to change water route. The deficiency of this structure is that, when rotating the mandrels in the receiving chamber, the tight seal ring is liable to be scratched and damaged by the rim of the opening of the receiving chamber, to adversely affect tight seal effect, hereby leading to function failure.

2. Adopting a side spiral approach, to control movement of valve cartridge. The drawback of this approach is that, to achieve water route switching, it requires to rotate the knob many turns. Therefore, it is rather time consuming, and not convenient to operate; while its structure is complicated, and its stability is insufficient.

Therefore, presently, the design and performance of the bypass valve is not quite satisfactory, and it leaves much room for improvements.

### SUMMARY OF THE INVENTION

In view of the problems and drawbacks of the prior art, the present invention provides a bypass valve, that is novel in design, and easy in operation.

The present invention provides a bypass valve, that includes a first main body and a second main body. For the first main body, its two ends are disposed a water inlet port and a water outlet port respectively. A mandrel capable of moving laterally is disposed in the first main body; and a water passage channel is disposed in the mandrel, for connecting and communicating the water inlet port with the water outlet port. The second main body is disposed below the first main body. In the second main body is disposed a water inlet channel and a water outlet channel. A first water passage hole is disposed between the water outlet channel and the water inlet port, and a second water passage hole is disposed between the water inlet channel and the water outlet port. Wherein, on the mandrel is disposed a first tight seal ring for opening or closing the first water passage hole; and on the mandrel is further disposed a second tight seal ring for controlling the water output port to connect and communicate to the water input channel or the water passage channel.

In an aspect of the present invention, the bypass valve further includes a third tight seal ring, disposed between the first tight seal ring and the second tight seal ring.

In another aspect of the present invention, the bypass valve further includes a water flow channel, disposed on the second main body, for connecting and communicating the water inlet channel with a water outlet channel; a push rod, disposed on the water flow channel; and a plug head, disposed at one end of the push rod, and is located in the water flow channel.

Compared with the Prior Art, the bypass valve of the present invention has the following advantages: firstly, in achieving switching, it requires only to pull the mandrel out once, so that its operation is simple and easy. Secondly, the bypass pump is capable of performing mixed water regulations. And thirdly, the design of the bypass pump utilizes a 90 degree configuration, to save the space occupied.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a perspective view of a bypass valve according to the present invention;

FIG. 2 is an exploded view of a bypass valve according to the present invention;

FIG. 3 is a schematic diagram of a bypass valve in a first condition according to the present invention;

FIG. 4 is a schematic diagram of a bypass valve in a second condition according to the present invention; and

FIG. 5 is a schematic diagram of a bypass valve in a third condition according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

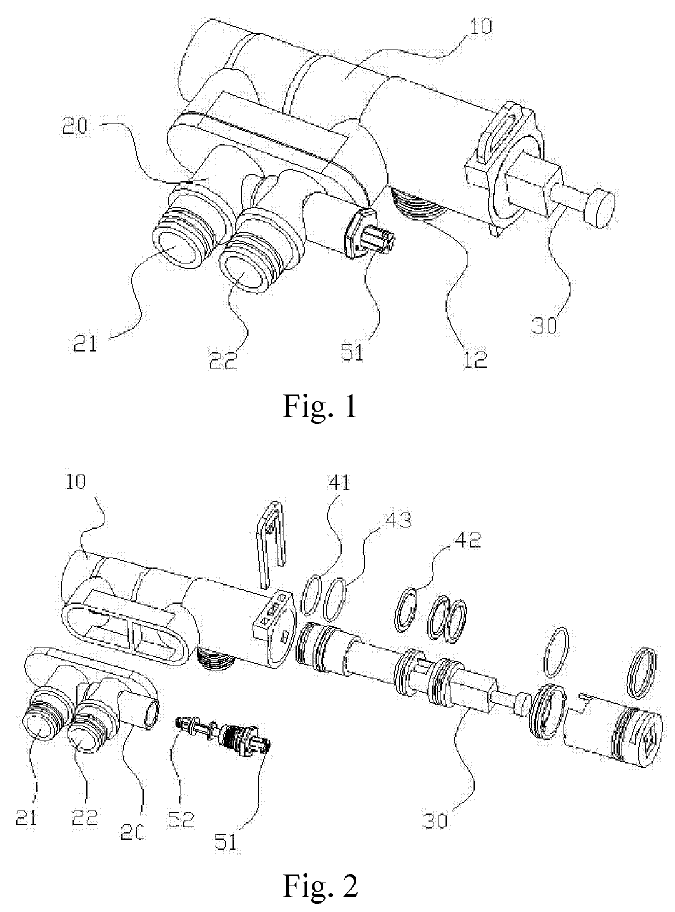

Refer to FIGS. 1-5 respectively for a perspective view of a bypass valve according to the present invention; an exploded view of a bypass valve according to the present invention; a schematic diagram of a bypass valve in a first condition according to the present invention; a schematic diagram of a bypass valve in a second condition according to the present invention; and a schematic diagram of a bypass valve in a third condition according to the present invention.

As shown in FIGS. 1-5, the present invention provides a bypass valve, and that includes: a first main body 10, a second main body 20.

The first main body 10 has its two ends disposed a water inlet port 11 and a water outlet port 12 respectively. A mandrel 30 capable of moving laterally is disposed in the first main body 10. And a water passage channel 31 is disposed in the mandrel 30, for connecting and communicating the water inlet port 11 with the water outlet port 12.

The second main body 20 is disposed below the first main body 10. In the second main body 20 is disposed a water inlet channel 22 and a water outlet channel 21. A first water passage hole 13 is disposed between the water outlet channel 21 and the water inlet port 11, and a second water passage hole 14 is disposed between the water inlet channel 22 and the water outlet port 12.

Wherein, on the mandrel 30 is disposed a first tight seal ring 41 for opening or closing the first water passage hole 13; and on the mandrel 30 is further disposed a second tight seal ring 42 for controlling the water output port 12 to connect and communicate with the water input channel 22 or the water passage channel 31.

In an embodiment of the present invention, the bypass valve further includes a third tight seal ring 43, disposed between the first tight seal ring 41 and the second tight seal ring 42.

In an embodiment of the present invention, the bypass valve further includes a water flow channel 23, disposed on the second main body 20, for connecting and communicating the water inlet channel 22 and a water outlet channel 21; a push rod 51 disposed on the water flow channel 23; and a plug head 52 is disposed at one end of the push rod 51, and is located in the water flow channel 23.

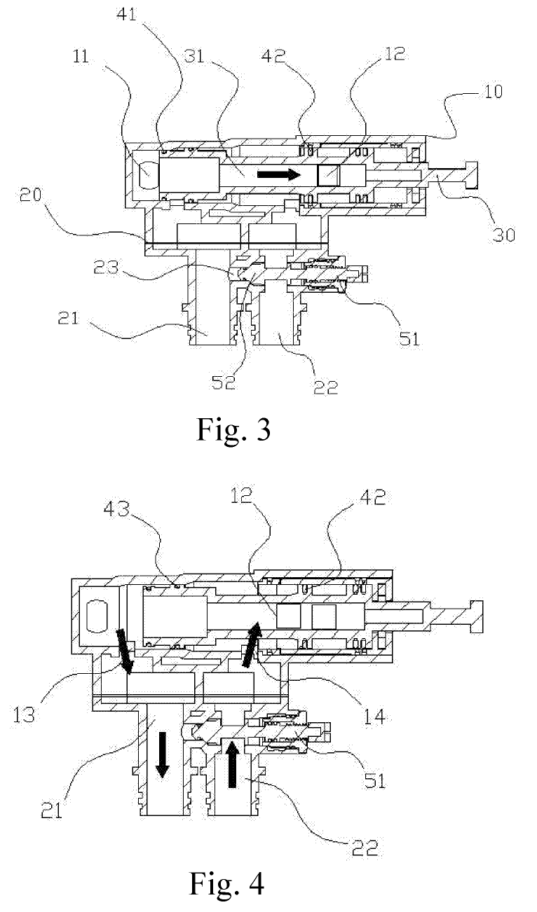

Refer to FIG. 3 for a schematic diagram of a bypass valve in a first condition according to the present invention. As shown in FIG. 3, when the mandrel 30 is at this position, that means the bypass valve is in a bypass state. The operation analyses are as follows: water flows in through the water inlet port 11 of the first main body 10, to pass through the first main body 10. At this time, the front end of the mandrel 30 is tightly sealed by the first tight seal ring 41, so water is allowed to flow through the water passage channel 31 and then the water passage through hole in the mandrel 3. Since the cooperation portion of the first main body 10 and the mandrel 30 is tightly sealed by the second tight seal ring 42, so water is allowed to flow out from the water outlet port 12, and not to the water inlet channel 22.

Refer to FIG. 4 for a schematic diagram of a bypass valve in a second condition according to the present invention. As shown in FIG. 4, when the mandrel 30 is pulled out to this position, the bypass valve is in a filtering state. The operation analyses are as follows: water flows in through the water inlet port 11 of the first main body 10, to pass through the first main body 10. A part of the water flows through the water passage channel 31 of the mandrel 30, then it flows out the water passage through hole. Since the cooperation part of the mandrel 30 and the first main body 10 is tightly sealed by the second tight seal ring 42, so that water is not allowed to flow through this route. However, the other part of the water flows through the first water passage hole 13 to the water outlet channel 21, and then flows into a water purifier. After purifying, the water flows through the water inlet channel 22 to the first main body 10 via the second water passage hole 14, and the water finally flows out from the water outlet port 12.

In the present invention, a mixed water regulating route is provided as described as follows:

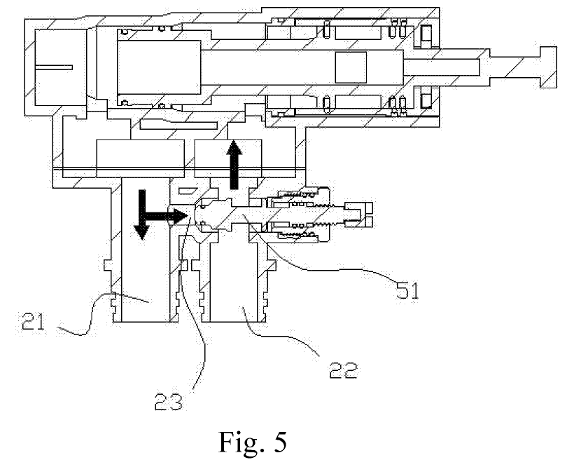

Refer to FIG. 5 for a schematic diagram of a bypass valve in a third condition according to the present invention. As shown in FIG. 5, while using condition 2 as a basis, such that water flows in through the water inlet port 11, and then it flows through the second main body 20. By controlling the push rod 51, a part of water flows into a water purifier the water outlet channel 21. The other part of the water flows out from the water flow channel 23 directly to the water outlet port 12. As such, a part of the water is not purified.

In the present invention, the mandrel 30 can be pulled out from one end of the bypass valve, to switch it into a filtering condition, the operation is easy, simple, and convenient. In addition, mixed water regulating function is provided. As shown in the drawings, in the filtering state, water flows in from the water inlet port 11. When the water flows through the second main body 20, through regulating the push rod 51, a part of the water flows into the water purifier through the water outlet channel. Meanwhile, the other part of the water flows out through the water flow channel 23, then it flows out from the water outlet port 12, such that the other part of the water is not purified. By adopting a 90 degree water route configuration, the raw water inlet port, raw water outlet port, and the purified water inlet port, purified water outlet port are formed into a 90 degree configuration, to save space of installation, thus the bypass valve may have wider scope of applications.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A bypass valve, comprising:
a first main body, with its two ends disposed a water inlet port and a water outlet port respectively, wherein a mandrel movable laterally is disposed in the first main body, and a water passage channel is disposed in the mandrel, for connecting and communicating the water inlet port with the water outlet port; and
a second main body, disposed below the first main body, wherein in the second main body is disposed a water inlet channel and a water outlet channel, a first water passage hole is disposed between the water outlet channel and the water inlet port, and a second water passage hole is disposed between the water inlet channel and the water outlet port,
wherein, on the mandrel is disposed a first tight seal ring for opening or closing the first water passage hole, and on the mandrel is further disposed a second tight seal ring for controlling the water output port to connect and communicate with the water input channel or the water passage channel.

2. The bypass valve as claimed in claim 1, further comprising:
a third tight seal ring, disposed between the first tight seal ring and the second tight seal ring.

3. The bypass valve as claimed in claim 1, further comprising:
a water flow channel, disposed on the second main body, for connecting and communicating the water inlet channel with a water outlet channel; a push rod, disposed on the water flow channel; and a plug head, disposed at one end of the push rod, and located in the water flow channel.
